(19) United States
(12) Patent Application Publication
(10) Pub. No.: US 2022/0198295 A1
(43) Pub. Date: Jun. 23, 2022

(54) COMPUTERIZED SYSTEM AND METHOD FOR IDENTIFYING AND APPLYING CLASS SPECIFIC FEATURES OF A MACHINE LEARNING MODEL IN A COMMUNICATION NETWORK

(71) Applicant: Verizon Patent and Licensing Inc., Basking Ridge, NJ (US)

(72) Inventors: Kushal SINGLA, Bangalore (IN); Subham BISWAS, Thane (IN)

(21) Appl. No.: 17/132,247

(22) Filed: Dec. 23, 2020

(51) Int. Cl. G06N 5/04; G06N 20/00

(52) U.S. Cl. CPC G06N 5/04; G06N 20/00

(57) ABSTRACT

Disclosed are systems and methods for improving interactions with and between computers in content providing, streaming and/or hosting systems supported by or configured with devices, servers and/or platforms. The disclosed systems and methods provide a novel machine learning framework that trains classifiers to identify specific features of input data. When implementing these trained classifiers in specific runtime environments, the important features of those specific environments can be identified and leveraged for directing the classifier to the vital information that is relevant to the environment. A customized classifier is thereby dynamically created and deployed which improves how data can be classified, thereby reducing false negatives and positives, and increasing confidence and reliance on how such classifiers can be implemented.

### BACKGROUND INFORMATION

Machine learning models employ computational learning via artificial intelligence algorithms. These models operate within computerized environments in order to make data- driven decisions based on the sensor/input data.

However, when applied to specific runtime environments, conventional models are encumbered with an oversupply of feature data that leads to false negatives and false positives in object identification. That is, the models act as they are trained, they analyze all of the input data and classify objects based on the totality of what is available to them, without any regard for what is being viewed and/or why the model is being employed. This not only leads to inaccurate results, but a drain of computational resources as models and classifiers are inaccurately applied and overused for unnecessary data analysis.

### BRIEF DESCRIPTION OF THE DRAWINGS

The features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram of a cellular network according to some embodiments of the present disclosure;

FIG. 2 is a block diagram illustrating components of an exemplary system according to some embodiments of the present disclosure;

FIGS. 3A-3B are flow diagrams illustrating a method for training a model for performing feature importance determinations according to some embodiments of the present disclosure;

FIG. 4 is a flow diagram illustrating a method for applying the trained model to a runtime environment according to some embodiments of the present disclosure; and

FIG. 5 is a block diagram illustrating a computing device showing an example of a client or server device used in various embodiments of the present disclosure.

### DETAILED DESCRIPTION OF EXAMPLE EMBODIMENTS

To solve the aforementioned and other problems, disclosed embodiments provide a novel framework for customizing how machine learning models are trained and implemented. The disclosed framework is configured to identify the most important or significant features of input data for a classifier when it is applied to a specific runtime environment. By focusing on the most important or relevant features of a runtime environment, the classifier's accuracy and efficiency are improved as it is able to focus on the key elements of what is being analyzed.

By way of a non-limiting example, if a classifier is being implemented to determine whether a camera is capturing an image of an apple or an orange, the most important feature to focus on from the collected camera data is the color data. The data indicating the size of each fruit is not as important, as an apple and orange typically are the same size. Thus, the classifier can be pre-trained prior to its deployment to focus on and analyze the color data for the captured images in order to determine which object is an apple and orange.

Thus, according to some embodiments, the disclosed systems and methods are directed to a novel mechanism for training classifiers to identify specific features of input data. When implementing these trained classifiers in specific runtime environments, the features that are uniquely important to those specific environments can be identified and leveraged for directing the classifier to the vital information that is relevant or useful to the environment. A customized classifier is thereby dynamically created and deployed which improves how data can be classified, thereby reducing false negatives and positives, and increasing confidence and reliance on how such classifiers can be implemented.

In some embodiments, a computerized method is disclosed that identifies a machine learning model and a training data set, where the training data set includes a set of features. For each of the features included in the set of features: i) the training data set is modified by identifying a feature within the set of features and modifying an initial value of the identified feature; ii) the machine learning model is executed based on the modified training data set; and iii) an impact value is computed that represents an impact that the modified training data set has on an output of the executed machine learning model. The method further determines a sorted list of features based on the computed impact value for each feature in the set of features, where the sorted list includes information indicating a determined class and value of each feature in the set of features. Thus, the machine learning model is effectively trained on the sorted list of features. The method then applies the trained machine learning model to a runtime environment.

In some embodiments, the application of the trained machine learning model includes identifying the runtime environment, then selecting the trained machine learning model based on the identified runtime environment. Sensor data from a device operating within the runtime environment is collected, and the trained machine learning model is executed with the collected sensor data as input, where the results are output.

In some embodiments, the output results are fed back to the computing device, system or platform executing the method for further training of the machine learning model.

In some embodiments, the method further includes analyzing the sorted list of features by comparing values of each feature output by the machine learning model; and determining, based on the analysis, whether any feature has been incorrectly assigned a class or value. In some embodiments, when it is determined that a feature within the set of features has had an incorrectly assigned class or value, the i) modifying, ii) executing and iii) computing steps are repeated in order to determine another sorted list.

In some embodiments, the computation of the impact value includes determining a feature importance of the modified feature for a particular class, where the determination of the feature importance is based on an original quality measure of the machine learning model and a quality measure of the machine learning model after training.

In some embodiments, modifying the training data further involves removing the identified feature from an input of the machine learning model during the execution.

In some embodiments, modifying the training data set includes shuffling values of at least a portion of the features in the set of features. In some embodiments, the shuffling is performed randomly.

In some embodiments, a device is disclosed comprising a processor that is configured to execute computer-executable instructions or program logic that produces a trained machine learning model in a similar manner discussed above, and in more detail below. In some embodiments, the processor identifies a machine learning model and a training data set, where the training data set includes a set of features. For each of the features included in the set of features: i) the training data set is modified by identifying a feature within the set of features and modifying an initial value of the identified feature; ii) the machine learning model is executed based on the modified training data set; and iii) an impact value is computed that represents an impact that the modified training data set has on an output of the executed machine learning model. The processor further determines a sorted list of features based on the computed impact value for each feature in the set of features, where the sorted list includes information indicating a determined class and value of each feature in the set of features. Thus, the machine learning model is effectively trained on the sorted list of features and is then capable of being applied to a runtime environment.

In some embodiments, a non-transitory computer-readable storage medium for storing instructions capable of being executed by a processor is disclosed. In these embodiments, execution of these instructions cause identification of a machine learning model and a training data set, where the training data set includes a set of features. For each of the features included in the set of features: i) the training data set is modified by identifying a feature within the set of features and modifying an initial value of the identified feature; ii) the machine learning model is executed based on the modified training data set; and iii) an impact value is computed that represents an impact that the modified training data set has on an output of the executed machine learning model. The instructions further cause a determination of a sorted list of features based on the computed impact value for each feature in the set of features, where the sorted list includes information indicating a determined class and value of each feature in the set of features. Thus, the machine learning model is effectively trained on the sorted list of features and is then capable of being applied to a runtime environment.

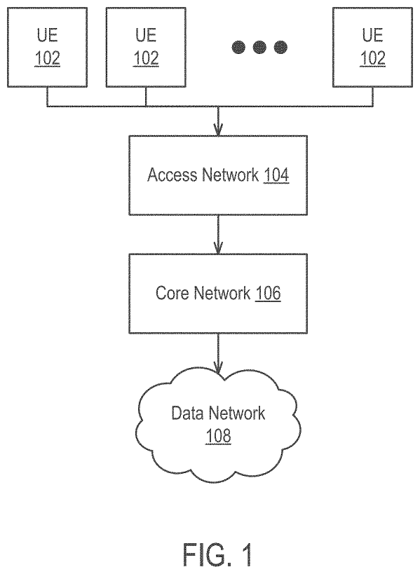

FIG. 1 is a block diagram of a cellular network according to some embodiments of the disclosure.

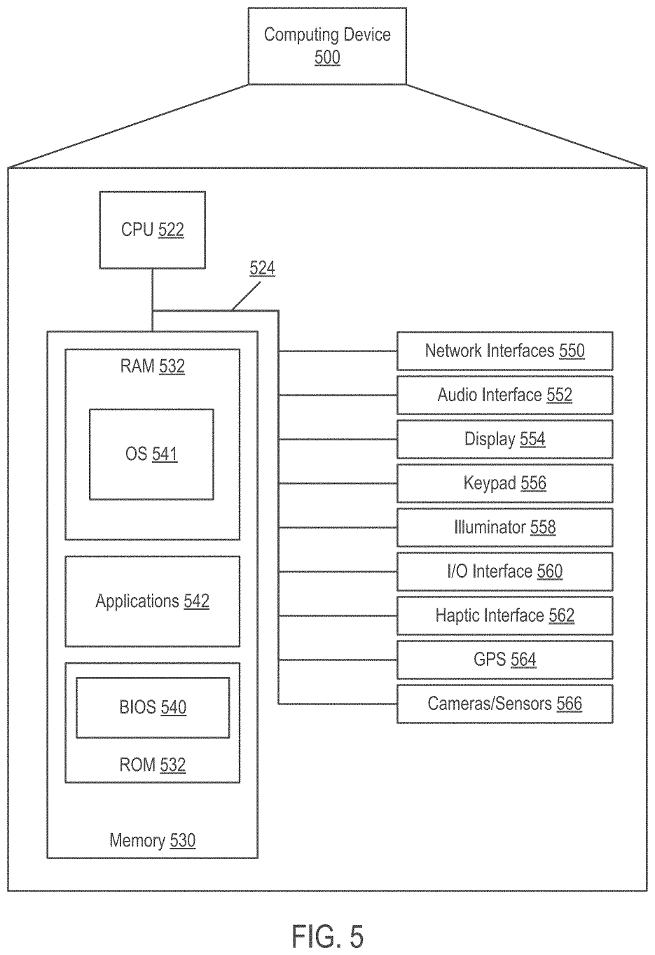

In the illustrated embodiment, user equipment (UE) 102 accesses a data network 108 via an access network 104 and a core network 106. In the illustrated embodiment, UE 102 comprises any computing device capable of communicating with the access network 104. As examples, UE 102 may include mobile phones, tablets, laptops, sensors, Internet of Things (IoT) devices, autonomous vehicles, and any other devices equipped with a cellular or wireless or wired transceiver. One example of a UE is provided in FIG. 5.

In the illustrated embodiment, the access network 104 comprises a network allowing over-the-air network communication with UE 102. In general, the access network 104 includes at least one base station that is communicatively coupled to the core network 106 and wirelessly coupled to zero or more UE 102.

In some embodiments, the access network 104 comprises a cellular access network, for example, a fifth-generation (5G) network or a fourth-generation (4G) network. In one embodiment, the access network 104 and UE 102 comprise a NextGen Radio Access Network (NG-RAN). In an embodiment, the access network 104 includes a plurality of next Generation Node B (gNodeB) base stations connected to UE 102 via an air interface. In one embodiment, the air interface comprises a New Radio (NR) air interface. For example, in a 5G network, individual user devices can be communicatively coupled via an X2 interface.

In the illustrated embodiment, the access network 104 provides access to a core network 106 to the UE 102. In the illustrated embodiment, the core network may be owned and/or operated by a mobile network operator (MNO) and provides wireless connectivity to UE 102. In the illustrated embodiment, this connectivity may comprise voice and data services.

At a high-level, the core network 106 may include a user plane and a control plane. In one embodiment, the control plane comprises network elements and communications interfaces to allow for the management of user connections and sessions. By contrast, the user plane may comprise network elements and communications interfaces to transmit user data from UE 102 to elements of the core network 106 and to external network-attached elements in a data network 108 such as the Internet.

In the illustrated embodiment, the access network 104 and the core network 106 are operated by an MNO. However, in some embodiments, the networks (104, 106) may be operated by a private entity and may be closed to public traffic. For example, the components of the network 106 may be provided as a single device, and the access network 104 may comprise a small form-factor base station. In these embodiments, the operator of the device can simulate a cellular network, and UE 102 can connect to this network similar to connecting to a national or regional network.

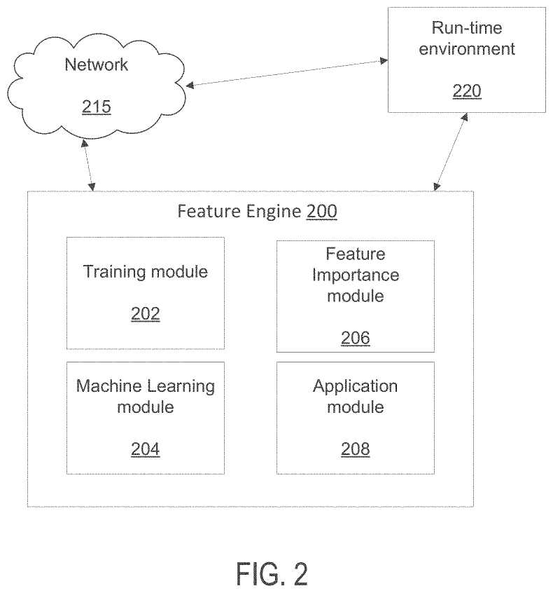

FIG. 2 is a block diagram illustrating the components for performing the systems and methods discussed herein. FIG. 2 includes feature engine 200, network 215 and runtime environment 220. The feature engine 200 can be a special purpose machine or processor and could be hosted by a cloud server (e.g., cloud web services server(s)), edge server, messaging server, application server, content server, social networking server, web server, search server, content provider, third party server, user's computing device, and the like, or any combination thereof. Engine 200 can be hosted within networks 104, 106 and/or 108, or some combinations thereof.

According to some embodiments, feature engine 200 can be embodied as a stand-alone application that executes on a user device. In some embodiments, the feature engine 200 can function as an application installed on the user's device, and in some embodiments, such application can be a web-based application accessed by the user device over a network. In some embodiments, the feature engine 200 can be installed as an augmenting script, program or application (e.g., a plug-in or extension) to another application (e.g., for example, to a navigation app running on a vehicle).

As discussed above, with reference to FIG. 1, the network 215 can be any type of network, such as, for example, but not limited to, a 5G (or 4G) network (as illustrated in FIG. 1), the Internet, and the like. The network 215 hosts and/or facilitates connectivity of the feature engine 200 and the runtime environment 220.

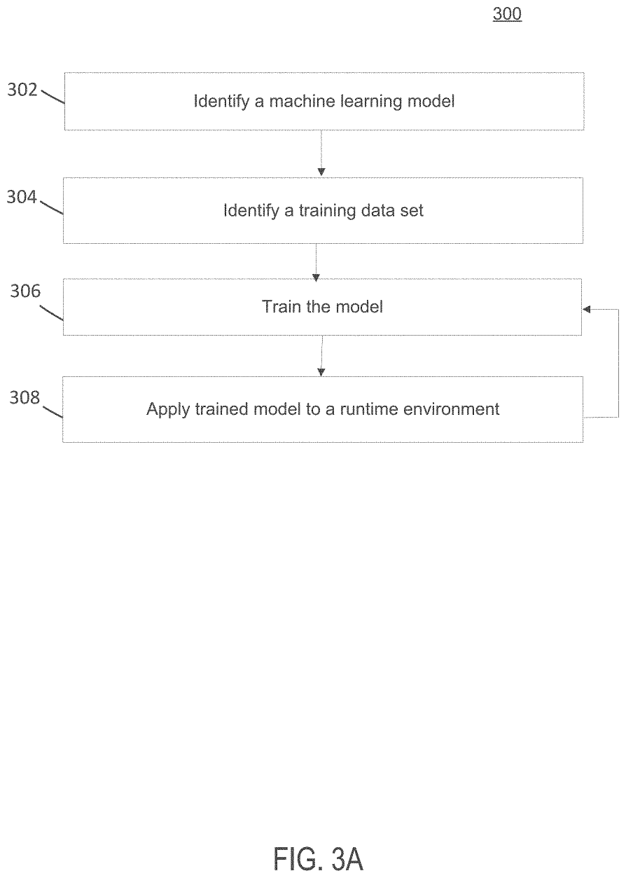

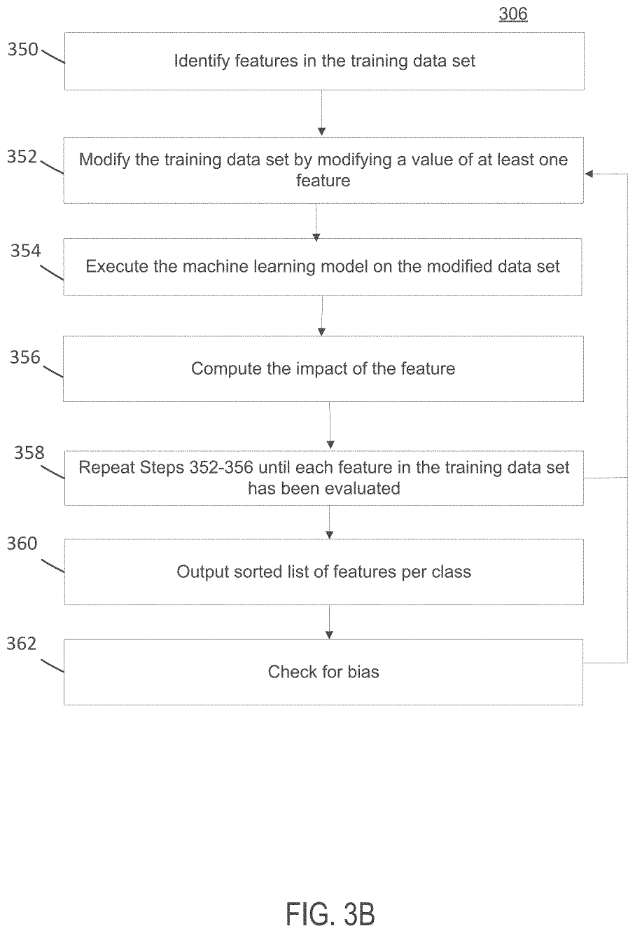

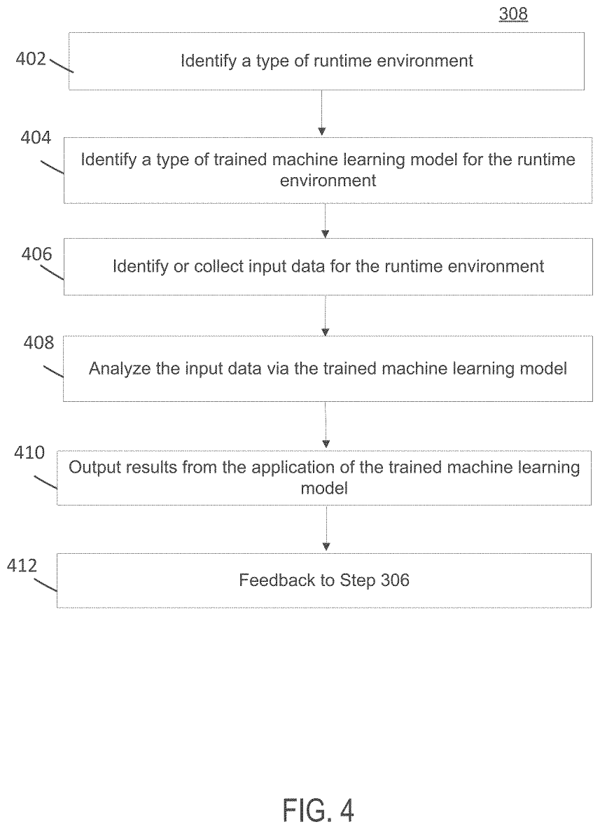

As illustrated in FIG. 2, and discussed in more detail with reference to FIGS. 3A-4 below, the feature engine 200 and runtime environment 220 can be directly connected by any known or to be known method of connecting and/or enabling communication between such devices and resources. In some embodiments, engine 200 can operate within environment 220; and in some embodiments, engine 200 can operate via a connected network 215 to environment 220.

The principal processor, server, or combination of devices that comprise hardware programmed in accordance with the special purpose functions herein is referred to for convenience as feature engine 200, and includes training module 202, machine learning module 204, feature importance module 206 and application module 208. The functionality and implementation of each of these modules will be discussed in detail below with reference to FIGS. 3A-4.

It should be understood that the engine(s) and modules discussed herein are non-exhaustive, as additional or fewer engines and/or modules (or sub-modules) may be applicable to the embodiments of the systems and methods discussed. The operations, configurations and functionalities of each module, and their role within embodiments of the present disclosure will be discussed below.

Turning to FIGS. 3A-3B, Process 300 details a method for training a machine learning model to perform feature importance determinations according to some embodiments of the present disclosure. Process 300 of FIG. 3A provides an overview of the training process, and FIG. 3B provides non-limiting details of the specific steps (of Step 306) for training a machine learning model.

According to some embodiments of FIG. 3A, Steps 302-304 of Process 300 are performed by training module 202 of feature engine 200; Step 306 is performed by training module 202, machine learning module 204 and feature importance module 206 (as discussed below in relation to FIG. 3B); and Step 308 is performed via application module 208.

Process 300 begins with Step 302 where a machine learning model is identified. The model, for example, can be any type of known or to be known machine learning model, such as, but not limited to, computer vision, Bayesian network analysis, Hidden Markov Models, artificial neural network analysis, data mining, image classifiers, logical model and/or tree analysis, and the like.

In some embodiments, Step 302 can involve identifying a specific type of model that is particular to a particular task, location, context or other type of criteria that correlates to a runtime environment.

For example, as discussed below, a runtime environment can involve 5G beam steering, where a user's actions need to be tracked. Therefore, a computer vision model can be identified in order to perform the required object tracking.

In Step 304, a training data set is identified. The training data set can correspond to a particular type of model (from Step 302), to a type of runtime environment, and the like, or some combination thereof. The training data set comprises a set of data with features specific to a certain type of class of objects.

For example, a model can be an image classifier which is used to determine which type of fruit is being captured in a set of video frames. Therefore, the training data set can comprise a set of fruit pictures. In some embodiments, the pictures can be subject to parsing and analysis, and feature extraction which provides information indicating the features (and their values) of each object per class. Thus, for each object class (e.g., apple and orange), the features of each item are identified. For example, for each class, the features can include, but are not limited to, the colors (e.g., according to a RGB color model), its size (e.g., pixel dimensions), and shape (e.g., sampling pitch).

By way of example, the below Table 1 illustrates a sample training data set for “fruits”: where R1 and R2 represent object types, where R1 represents an “apple”, and R2 represents an “orange”; F1-F3 are features, where F1=color, F2=size, and F3=shape; and C1 and C2 represent classes of objects.

TABLE 1

| | F1 | F2 | F3 | |
|---|---|---|---|---|
| R1 | 1 | 2 | 2 | C1 |
| R2 | 3 | 3 | 1 | C2 |

Process 300 proceeds to Step 306, where the identified model (from Step 302) is trained based on the identified training data set (from Step 304). As discussed herein, and in more detail in FIG. 3B, the training performed in the processing or sub-steps (350-362) of Step 306 enable a machine learning model to more accurately identify and leverage the important features of objects within a runtime environment.

According to some embodiments of FIG. 3B, Steps 350-352 and 358 are performed by training module 202 of feature engine 200; Step 354 is performed by machine learning module 204; and Steps 356 and 360-362 are performed by feature importance module 206.

The training of the model depicted in FIG. 3B begins with Step 350 where the features in the training data set are identified. In some embodiments, the identification of the features of a training data set can be performed in a similar manner discussed above in relation to Step 304.

As discussed above, the features correspond to the attributes, traits or characteristics of each type of object. For example, from Table 1 above, the features for objects R1 and R2 are F1, F2 and F3, respectively, where the numerals in the table indicate each feature's value.

As evident from the discussion herein, the following Steps 352-356 are performed for each of the features identified in the training data set. For example, if the training data set corresponds to “fruits”, as discussed as an example above, and the three features are color, size and shape, then Steps 352-356 are performed recursively three (3) times, once for each feature, until the process of Step 306 can move from Step 356 to Step 360.

In Step 352, the training data set is modified. In some embodiments, the modification of the training data set involves “shuffling” the feature values. Such shuffling is performed by randomly assigning (or re-assigning) a value of a feature (N) (e.g., feature N's initial value to another randomly assigned value). In some embodiments, the shuffling can be performed in accordance with a portion of the features or all of the features.

In some embodiments, the modification can involve removing a feature (N) from the training data set (e.g., deleting it, or assigning it a null value so it is ignored).

For example, according to Step 352, F1 can be the modified feature (N) within the training data set of Table 1. In subsequent loops of this process, F2 is then modified, then F3; however, the specific order is not limiting, as any feature can be modified in any order.

In Step 354, engine 200 executes the machine learning model on the modified (or shuffled) training data set. The model predictions for the identified model are computed based on the modified training data set that has had a feature modified (e.g., its value randomized via the shuffling).

In Step 356, engine 200 computes the impact of the modification of the training set. The impact can be based on a quality measure for the model, for a specific class (M). For example, the quality measure can correspond to a precision or recall value.

According to some embodiments, the impact computation can be realized, as follows:

FN_CM_imp=Orig_MO_acc−REM_FN_CM_acc, (Eq. 1),

where “FN_CM_imp” is the feature importance of the modified feature N for a specific class M, “Orig_MO_acc” is the original model quality measure (e.g., original precision or recall), and “REM_FN_CM acc” is the class M specific model quality (e.g., precision or recall) after the modification of feature N.

For example, a precision measure, represented by “Orig_MO_acc”, before feature shuffling is 0.9793, and after shuffling, the precision measure, represented by “REM_FN_CM_acc”, is 0.9657; therefore, the “FN_CM_imp” for the first modified feature N is: 0.0136.

Having computed the feature importance for the first modified feature, the process of Step 306 loops back to Step 352 until all the features have been modified/shuffled, as discussed above. Step 358.

When engine 200 determines that all of the features have been modified/shuffled, then the process of Step 306 continues to Step 360, where a sorted listed of features per class are determined and output by engine 200. In some embodiments, the list is sorted with the greater feature importance scores (“FN_CM_imp”) being sorted higher than the lower scores.

For example, according to the “fruit” example discussed above in relation to Table 1, if when F1 (color) was modified, the score was higher than when F2 (size) was modified, this indicates that F1 (color) feature is more important than F2 (size) for properly identifying/classifying the objects.

Thus, taking the input as Table 1's training data, the output sorted list of Step 360 can be realized as Table 2:

| | F1 | F2 | F3 |
|---|---|---|---|
| C1 | 1 | 2 | 3 |
| C2 | 3 | 1 | 2 |

Here, by way of a non-limiting example, the most important features are identified as F1, and each type of object (R1 and R2) are classified as C1or C2. As mentioned above, this is only one potential output, as the output of Step 360 produces a sorted feature list for each of the C1, C2 classes for each row.

Thus, for example, using the above “fruit” example, in one iteration of a sorted list output, the apple is classified as C1 and orange is classified as C2. Their important features are identified as color, then shape then size, as illustrated in the above table for F1, F2 and F3, and the included values depicted therein.

In another non-limiting example, in a 5G beam steering environment, R1 and R2 correspond to two separate UE speeds, where features F1, F2 and F3 correspond to their size, shape and signal strength, respectively. Thus, in one iteration of a sorted list output, R1 is classified as a slow UE speed (C1), and R2 is classified as a fast UE speed (C2). For example, C1 has sorted features of size, then shape, then strength (F1, F2, F3); and C2 has sorted features of shape, then size, then strength (F2, F1, F3).

According to some embodiments, the processing of Step 306 then continues to Step 362 where the sorted list of features is checked for bias. According to some embodiments, the bias check, for example, analyzes the precision of the output data to determine and prevent the system from being misled by inaccurately relied upon features.

Step 362 involves performing an audit of the sorted results prior to the trained model's deployment to a runtime environment. The auditing (or bias check) involves analyzing the sorted list compared to the initial training data set, and determining whether any bias existed that causes certain features to be characterized as more important than others.

For example, a computer vision model is being trained on a training data set of user tracking data for use in a 5G beam steering environment. Engine 200 here, for example, analyzes the output results of sorted features to determine whether certain demographics of users are being prioritized over others. The system wants to ensure that all users are being provided the same quality of 5G service, and determining whether certain types of users are having their features prioritized against others works to ensure the equitable distribution of the 5G beam.

In another non-limiting example, a computer vision model is being trained on a training data set of images of street signs for use by an autonomous vehicle. The auditing performed herein can check for whether the model is focusing on the correct portions of signs, rather than unimportant portions of signs. For example, analysis of the model's precision or recall in correctly determining and/or differentiating between a crossroad sign, a side road sign, a “T” intersection sign, and a “Y” intersection sign is performed by engine 200 in order to ensure the instructions being relayed by a sign are properly being understood and not misinterpreted.

In embodiments where a threshold level of bias is detected, determined or otherwise identified, the processing of Step 306 can revert back to Step 352 to re-perform each of the steps again for each of the features.

When bias is not detected, the model is saved and considered trained to identify the important class specific features, such that when it is deployed in a runtime environment, the model can decipher which features are important to that situation and properly, accurately and efficiently classify the objects depicted therein. A discussion of these embodiments are discussed below in reference to Step 308 of FIG. 3A and the corresponding steps of FIG. 4.

Turning back to FIG. 3A, at the conclusion of training the model via the sub-steps/processing of Step 306 depicted in FIG. 3B, Process 300 proceeds to Step 308, where the model is applied, implemented or executed within a runtime environment.

The processing sub-steps of Step 308 are detailed in Steps 402-412 of FIG. 4. According to some embodiments, the steps of FIG. 4 are performed via application module 208 of feature engine 200.

The processing of FIG. 4 begins with Step 402, where a type of runtime environment is identified. In some embodiments, the environment can be the runtime environment identified in Step 302, as discussed above. In some embodiments, the runtime environment can be input, or pre-programmed or selected. According to embodiments of the present disclosure, a type of runtime environment can be any type of real-world, digital or virtual environment, or combination thereof. For purposes of explanation below, as use cases, example embodiments include, but are not limited to, 5G beam steering and autonomous driving.

As understood by those of skill in the art, 5G beam steering is a technique that uses models for tracking movement of UE to identify UE speeds (e.g., slow, medium, fast) in order to improve the spectrum allocation, connection and UE speed prediction for providing 5G connectivity.

As understood by those of skill in the art, autonomous driving is a technique that tracks objects on and near the road (e.g., people, animals, signs, lights, weather, and the like) in order to automatically steer, drive or provide driver assist to vehicles and avoid collisions.

In each of these environments, it is important to identify the specific features that models operating therein rely upon, which is realized via the application of the trained model, as performed in Step 404-406 below. For example, within 5G beam steering, it is important to identify UE speed and location. In an autonomous driving example, it is important to identify and focus on object sizes, locations, shapes and colors, for example.

In Step 404, a type of trained machine learning model for the runtime environment is identified. In some embodiments, the type of model can be selected based on a type of runtime environment.

By way of a non-limiting example of Steps 402-404, in a 5G beam steering environment or autonomous driving environment (Step 402), a computer vision model can be identified (Step 404). The computer vision model can be implemented to detect and/or track unique or specific features for each environment. For example, in the 5G beam steering environment, the model can track user's movements based on data received from the user's mobile device; and, in the autonomous driving environment, the model can check for street signs, postings, lights, pedestrians, or other traffic related objects to steer a vehicle.

In Step 406, the input or sensor data for the runtime environment is identified or collected.

For example, in a 5G beam steering environment, the input/sensor data can be Global Positioning Service (GPS) data collected and monitored from a user's mobile phone.

In another example, in an autonomous driving environment, the input/sensor data can be objects detected from the vehicles camera(s) or light detection and ranging (Lidar) sensors.

In Step 408, the input data is analyzed via the trained machine learning algorithm (from Steps 306 and 404). In some embodiments, the analysis is performed continuously or periodically as the input data is collected. This enables, for example, the computer vision model to focus on the important features of the input data to perform real-time tracking of the user within the 5G beam steering environment, and the real-time traffic detection within the autonomous driving environment.

In Step 410, the results of the model's application are output and provided to the system deploying the model. Thus, the model is analyzing the important class features specific to the runtime environment, which enables the improved accuracy and efficiency in the model's implementation.

For example, in the 5G beam steering environment, the outputting enables a cell tower(s) to track a user's movements and location so that 5G network connectivity can be supplied to the user's device continuously. In another example, in the autonomous driving environment, the outputting can be provided to the electronic control unit (ECU) of the vehicle thereby enabling it to properly steer, accelerate, decelerate, brake and the like.

In Step 412, the results from Step 410 are compiled as feedback in order to further train the model (Process 300 recursively loops to Step 306 to train a selected model further based on the output of the runtime deployment of FIG. 4). These results can improve how the models not only operate and function, but also how they efficiently and accurately identify the runtime specific features that are vital to the model's operation within those specific runtimes, as illustrated above in the 5G beam steering and autonomous driving environments.

FIG. 5 is a block diagram illustrating a computing device showing an example of a client or server device used in the various embodiments of the disclosure.

The computing device 500 may include more or fewer components than those shown in FIG. 5, depending on the deployment or usage of the device 500. For example, a server computing device, such as a rack-mounted server, may not include audio interfaces 552, displays 554, keypads 556, illuminators 558, haptic interfaces 562, Global Positioning Service (GPS) receivers 564, or cameras/sensors 566. Some devices may include additional components not shown, such as graphics processing unit (GPU) devices, cryptographic co-processors, artificial intelligence (AI) accelerators, or other peripheral devices.

As shown in FIG. 5, the device 500 includes a central processing unit (CPU) 522 in communication with a mass memory 530 via a bus 524. The computing device 500 also includes one or more network interfaces 550, an audio interface 552, a display 554, a keypad 556, an illuminator 558, an input/output interface 560, a haptic interface 562, an optional global positioning systems (GPS) receiver 564 and a camera(s) or other optical, thermal, or electromagnetic sensors 566. Device 500 can include one camera/sensor 566 or a plurality of cameras/sensors 566. The positioning of the camera(s)/sensor(s) 566 on the device 500 can change per device 500 model, per device 500 capabilities, and the like, or some combination thereof.

In some embodiments, the CPU 522 may comprise a general-purpose CPU. The CPU 522 may comprise a single-core or multiple-core CPU. The CPU 522 may comprise a system-on-a-chip (SoC) or a similar embedded system. In some embodiments, a GPU may be used in place of, or in combination with, a CPU 522. Mass memory 530 may comprise a dynamic random-access memory (DRAM) device, a static random-access memory device (SRAM), or a Flash (e.g., NAND Flash) memory device. In some embodiments, mass memory 530 may comprise a combination of such memory types. In one embodiment, the bus 524 may comprise a Peripheral Component Interconnect Express (PCIe) bus. In some embodiments, the bus 524 may comprise multiple busses instead of a single bus.

Mass memory 530 illustrates another example of computer storage media for the storage of information such as computer-readable instructions, data structures, program modules, or other data. Mass memory 530 stores a basic input/output system (“BIOS”) (540) for controlling the low-level operation of the computing device 500. The mass memory also stores an operating system 541 for controlling the operation of the computing device 500

Applications 542 may include computer-executable instructions which, when executed by the computing device 500, perform any of the methods (or portions of the methods) described previously in the description of the preceding Figures. In some embodiments, the software or programs implementing the method embodiments can be read from a hard disk drive (not illustrated) and temporarily stored in RAM 532 by CPU 522. CPU 522 may then read the software or data from RAM 532, process them, and store them to RAM 532 again.

The computing device 500 may optionally communicate with a base station (not shown) or directly with another computing device. Network interface 550 is sometimes known as a transceiver, transceiving device, or network interface card (NIC).

The audio interface 552 produces and receives audio signals such as the sound of a human voice. For example, the audio interface 552 may be coupled to a speaker and microphone (not shown) to enable telecommunication with others or generate an audio acknowledgment for some action. Display 554 may be a liquid crystal display (LCD), gas plasma, light-emitting diode (LED), or any other type of display used with a computing device. Display 554 may also include a touch-sensitive screen arranged to receive input from an object such as a stylus or a digit from a human hand.

Keypad 556 may comprise any input device arranged to receive input from a user. Illuminator 558 may provide a status indication or provide light.

The computing device 500 also comprises an input/output interface 560 for communicating with external devices, using communication technologies, such as USB, infrared, Bluetooth™, or the like. The haptic interface 562 provides tactile feedback to a user of the client device.

The optional GPS transceiver 564 can determine the physical coordinates of the computing device 500 on the surface of the Earth, which typically outputs a location as latitude and longitude values. GPS transceiver 564 can also employ other geo-positioning mechanisms, including, but not limited to, triangulation, assisted GPS (AGPS), E-OTD, CI, SAI, ETA, BSS, or the like, to further determine the physical location of the computing device 500 on the surface of the Earth. In one embodiment, however, the computing device 500 may communicate through other components, provide other information that may be employed to determine a physical location of the device, including, for example, a MAC address, IP address, or the like.

The present disclosure has been described with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in some embodiments” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure has been described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure, a non-transitory computer readable medium (or computer-readable storage medium/media) stores computer data, which data can include computer program code (or computer-executable instructions) that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, cloud storage, magnetic cassettes, magnetic tape, magnetic disk storage or other magnetic storage devices, or any other physical or material medium which can be used to tangibly store the desired information or data or instructions and which can be accessed by a computer or processor.

To the extent the aforementioned implementations collect, store, or employ personal information of individuals, groups, or other entities, it should be understood that such information shall be used in accordance with all applicable laws concerning the protection of personal information. Additionally, the collection, storage, and use of such information can be subject to the consent of the individual to such activity, for example, through well known “opt-in” or “opt-out” processes as can be appropriate for the situation and type of information. Storage and use of personal information can be in an appropriately secure manner reflective of the type of information, for example, through various access control, encryption, and anonymization techniques (for especially sensitive information).

In the preceding specification, various example embodiments have been described with reference to the accompanying drawings. However, it will be evident that various modifications and changes may be made thereto, and additional embodiments may be implemented without departing from the broader scope of the disclosed embodiments as set forth in the claims that follow. The specification and drawings are accordingly to be regarded in an illustrative rather than restrictive sense.

What is claimed is:

1. A method comprising:
identifying, by a computing device, a machine learning model and a training data set, the training data set comprising a set of features;
for each of the features included in the set of features:
modifying the training data set by identifying a feature within the set of features and modifying an initial value of the identified feature;
executing the machine learning model based on the modified training data set;
computing an impact value representing an impact that the modified training data set has on an output of the executed machine learning model;
determining, by the computing device, a sorted list of features based on the computed impact value for each feature in the set of features, the sorted list comprising information indicating a determined class and value of each feature in the set of features, wherein the machine learning model is trained on the sorted list of features; and
applying, by the computing device, the trained machine learning model to a runtime environment.

2. The method of claim 1, wherein said application of the trained machine learning model comprises:
identifying the runtime environment;
selecting the trained machine learning model based on the runtime environment;
collecting sensor data from a device operating within said runtime environment;
executing the trained machine learning model with the collected sensor data as input; and
outputting results of the execution of the trained machine learning model.

3. The method of claim 2, wherein the output results are fed back to the computing device for further training of the machine learning model.

4. The method of claim 1, further comprising:
analyzing the sorted list of features by comparing values of each feature output by the machine learning model; and
determining, based on said analysis, whether any feature has been incorrectly assigned a class or value.

5. The method of claim 4, further comprising:
when it is determined that a feature within the set of features has had an incorrectly assigned class or value, repeating the modifying, executing and computing steps in order to determine another sorted list.

6. The method of claim 1, wherein the computation of the impact value comprises determining a feature importance of the modified feature for a particular class.

7. The method of claim 6, wherein the determination of the feature importance is based on an original quality measure of the machine learning model and a quality measure of the machine learning model after training.

8. The method of claim 1, wherein modifying the training data further comprises removing the identified feature from an input of the machine learning model during said execution.

9. The method of claim 1, wherein modifying the training data set comprises shuffling values of at least a portion of the features in the set of features.

10. The method of claim 9, wherein said shuffling is performed randomly.

11. A device comprising:
a processor configured to:
identify a machine learning model and a training data set, the training data set comprising a set of features;
for each of the features included in the set of features:
modify the training data set by identifying a feature within the set of features and modifying an initial value of the identified feature;
execute the machine learning model based on the modified training data set;
compute an impact value representing an impact that the modified training data set has on an output of the executed machine learning model;
determine a sorted list of features based on the computed impact value for each feature in the set of features, the sorted list comprising information indicating a determined class and value of each feature in the set of features, wherein the machine learning model is trained on the sorted list of features; and
apply the trained machine learning model to a runtime environment.

12. The device of claim 11, wherein said application of the trained machine learning model comprises:
identify the runtime environment;
select the trained machine learning model based on the runtime environment;
collect sensor data from a device operating within said runtime environment;
execute the trained machine learning model with the collected sensor data as input; and
output results of the execution of the trained machine learning model.

13. The device of claim 11, further comprising:
analyze the sorted list of features by comparing values of each feature output by the machine learning model; and
determine, based on said analysis, whether any feature has been incorrectly assigned a class or value, wherein when it is determined that a feature has had an incorrectly assigned class or value, repeating the modifying, executing and computing steps in order to determine another sorted list.

14. The device of claim 11, wherein the computation of the impact value comprises determining a feature importance of the modified feature for a particular class, wherein the determination of the feature importance is based on an original quality measure of the machine learning model and a quality measure of the machine learning model after training.

15. The device of claim 11, wherein modifying the training data set comprises randomly shuffling values of at least a portion of the features in the set of features.

16. A non-transitory computer-readable medium tangibly encoded with instructions, that when executed by a processor, perform a method comprising:
identifying a machine learning model and a training data set, the training data set comprising a set of features;
for each of the features included in the set of features:
modifying the training data set by identifying a feature within the set of features and modifying an initial value of the identified feature;
executing the machine learning model based on the modified training data set;
computing an impact value representing an impact that the modified training data set has on an output of the executed machine learning model;
determining a sorted list of features based on the computed impact value for each feature in the set of features, the sorted list comprising information indicating a determined class and value of each feature in the set of features, wherein the machine learning model is trained on the sorted list of features; and
applying the trained machine learning model to a runtime environment.

17. The non-transitory computer-readable medium of claim 16, wherein said application of the trained machine learning model comprises:
identifying the runtime environment;
selecting the trained machine learning model based on the runtime environment;
collecting sensor data from a device operating within said runtime environment;
executing the trained machine learning model with the collected sensor data as input; and
outputting results of the execution of the trained machine learning model.

18. The non-transitory computer-readable medium of claim 16, further comprising:
analyzing the sorted list of features by comparing values of each feature output by the machine learning model; and
determining, based on said analysis, whether any feature has been incorrectly assigned a class or value, wherein when it is determined that a feature has had an incorrectly assigned class or value, repeating the modifying, executing and computing steps in order to determine another sorted list.

19. The non-transitory computer-readable medium of claim 16, wherein the computation of the impact value comprises determining a feature importance of the modified feature for a particular class, wherein the determination of the feature importance is based on an original quality measure of the machine learning model and a quality measure of the machine learning model after training.

20. The non-transitory computer-readable medium of claim 16, wherein modifying the training data set comprises randomly shuffling values of at least a portion of the features in the set of features.
